(19) United States
(12) Patent Application Publication
(10) Pub. No.: US 2004/0189918 A1
(43) Pub. Date: Sep. 30, 2004

(54) Liquid crystal display and panel therefor

(75) Inventors: Chang-Hun Lee, Yongin-si (KR); Eun-Hee Han, Seoul (KR); Hak-Sun Chang, Seoul (KR)

Correspondence Address: McGuireWoods LLP, 1750 Tysons Boulevard, Suite 1800, McLean, VA, 22102, US

(73) Assignee: Samsung Electronics Co., Ltd.

(21) Appl. No.: 10/809,392

(22) Filed: Mar. 26, 2004

(30) Foreign Application Priority Data
Mar. 26, 2003 (KR) 2003-0018784

(51) Int. Cl. G02F 1/1343

(52) U.S. Cl. 349/141

(57) ABSTRACT

A liquid crystal display is provided, which includes: first and second substrates; a common electrode formed on the first substrate; a common electrode line connected to the common electrode and making an obtuse angle with the common electrode; a pixel electrode formed on the first substrate and alternately arranged with the common electrode; a pixel electrode line connected to the pixel electrode and making an obtuse angle with the pixel electrode; and a liquid crystal layer interposed between the first and the second substrates, wherein a first edge of the common electrode line makes an obtuse angle relative to an initial molecular director and a first edge of the pixel electrode line makes an obtuse angle relative to the initial molecular director.

### BACKGROUND OF THE INVENTION

(a) Field of the Invention

The present invention relates to a liquid crystal display and a panel therefor.

(b) Description of the Related Art

A liquid crystal display (LCD) is one of the most widely used flat panel displays. An LCD includes two panels provided with field-generating electrodes and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

Among LCDs including field-generating electrodes on respective panels, a kind of LCDs called in-plane switching (IPS) mode LCD provides a plurality of pixel electrodes and a plurality of common electrodes at one panel. The pixel electrodes and the common electrodes are alternately arranged and generate an electric field substantially parallel to surface of the panels. The IPS LCD is known to have superior viewing angle to a twisted-nematic (TN) mode LCD.

The common electrodes and the pixel electrodes are connected by a common electrode line and a pixel electrode line, respectively, which overlaps each other. However, texture is generated near the connections between the common electrodes and the common electrode line and between the pixel electrodes and the pixel electrode line to decrease the transmittance of light.

### SUMMARY OF THE INVENTION

A motivation of the present invention is to solve the problems of the conventional art.

A liquid crystal display is provided, which includes: first and second substrates; a common electrode formed on the first substrate; a common electrode line connected to the common electrode and making an obtuse angle with the common electrode; a pixel electrode formed on the first substrate and alternately arranged with the common electrode; a pixel electrode line connected to the pixel electrode and making an obtuse angle with the pixel electrode; and a liquid crystal layer interposed between the first and the second substrates, wherein a first edge of the common electrode line makes an obtuse angle relative to an initial molecular director and a first edge of the pixel electrode line makes an obtuse angle relative to the initial molecular director.

When the initial molecular director makes clockwise acute angles relative to the common electrode and the pixel electrode, it preferably makes counterclockwise obtuse angles with the edges of the common electrode line and the pixel electrode line.

When the initial molecular director makes counterclockwise acute angles relative to the common electrode and the pixel electrode, it preferably makes clockwise obtuse angles with the edges of the common electrode line and the pixel electrode line.

A second edge of the common electrode line may extend substantially perpendicular to the common electrode, and a second edge of the pixel electrode line may extend substantially perpendicular to the pixel electrode.

The pixel electrode and the common electrode may be curved.

A second edge of the common electrode line may be oblique to the common electrode and a second edge of the pixel electrode line may be oblique to the pixel electrode.

A pitch of the curving of the pixel electrode and the common electrode may be larger than about 50 microns.

A panel for a liquid crystal display is provided, the panel includes:

a substrate; a common electrode formed on the substrate; a common electrode line connected to the common electrode and making an obtuse angle with the common electrode; a pixel electrode formed on the substrate and alternately arranged with the common electrode; a pixel electrode line connected to the pixel electrode and making an obtuse angle with the pixel electrode; and an alignment layer formed on the substrate and rubbed in a direction, wherein a first edge of the common electrode line makes an obtuse angle relative to the rubbed direction and a first edge of the pixel electrode line makes an obtuse angle relative to the rubbed direction.

When the rubbed direction makes clockwise acute angles relative to the common electrode and the pixel electrode, it makes counterclockwise obtuse angles with the edges of the common electrode line and the pixel electrode line.

When the rubbed direction makes counterclockwise acute angles relative to the common electrode and the pixel electrode, it makes clockwise obtuse angles with the edges of the common electrode line and the pixel electrode line.

### BRIEF DESCRIPTION OF THE DRAWINGS

The present invention will become more apparent by describing embodiments thereof in detail with reference to the accompanying drawings in which:

FIG. 1 is a layout view of an LCD according to an embodiment of the present invention;

FIG. 2 is a sectional view of the LCD shown in FIG. 1 taken along the lines I-I′ and II-II′;

FIG. 3 is an expanded view of a common electrode line and a pixel electrode line as well as common electrodes and pixel electrodes connected thereto in an LCD according to an embodiment of the present invention;

FIGS. 4 and 5 are expanded views of a common electrode line and a pixel electrode line as well as common electrodes and pixel electrodes connected thereto in LCDs according to comparative examples of the present invention;

FIG. 6 is a layout view of an LCD according to another embodiment of the present invention; and

FIG. 7 is an expanded view of a common electrode line and a pixel electrode line as well as common electrodes and pixel electrodes connected thereto in the LCD shown in FIG. 6.

### DETAILED DESCRIPTION OF EMBODIMENTS

The present invention now will be described more fully hereinafter with reference to the accompanying drawings, in which preferred embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

Now, liquid crystal displays and TFT array panels for LCDs according to embodiments of the present invention will be described with reference to the accompanying drawings.

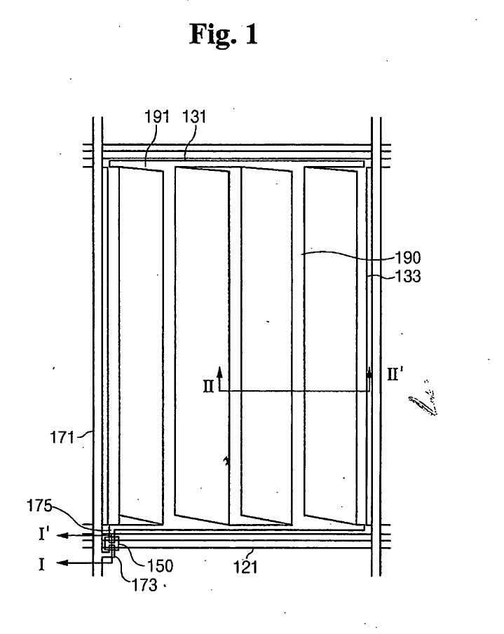

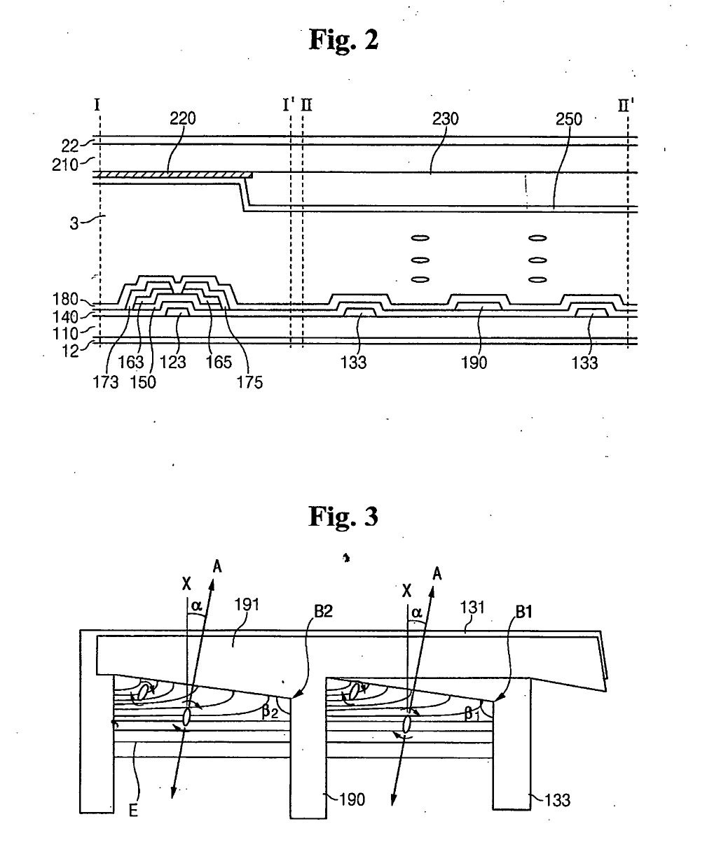

FIG. 1 is a layout view of an LCD according to an embodiment of the present invention, and FIG. 2 is a sectional view of the LCD shown in FIG. 1 taken along the lines I-I′ and II-II′.

Referring to FIGS. 1 and 2, a liquid crystal display according to an embodiment of the present invention includes a lower panel, an upper panel facing the lower panel, and a liquid crystal layer 3 interposed therebetween.

The lower panel is described in detail.

A plurality of gate lines 121 for transmitting gate signals and a plurality of pairs of common electrode lines 131 for transmitting a common voltage are formed on an insulating substrate 110.

Each gate line 121 extends substantially in a transverse direction and a plurality of portions of each gate line 121 form a plurality of gate electrodes 123.

Each pair of common electrode lines 131 extend substantially in the transverse direction and include a plurality of sets of common electrodes 133 extending substantially in a longitudinal direction to be connected between the pair of the common electrode lines 131. The common electrode lines 131 are supplied with a predetermined voltage called a common voltage and inner edges of the common electrode lines 131 are oblique to inner edges of the common electrodes 133.

The gate lines 121 and the common electrode lines 131 are preferably made of Al and Al alloy, Ag containing metal such as Ag and Ag alloy, Cu containing metal such as Cu and Cu alloy, Cr, Mo, Mo alloy, Ta, or Ti. They may have a multi-layered structure.

In addition, the lateral sides of the gate lines 121 and the common electrode lines 131 are inclined relative to a surface of the substrate 110, and the inclination angle thereof ranges about 30-80 degrees.

A gate insulating layer 140 preferably made of silicon nitride (SiNx) is formed on the gate lines 121 and the common electrode lines 131.

A plurality of semiconductor islands 150 preferably made of hydrogenated amorphous silicon (abbreviated to “a-Si”) or polysilicon are formed on the gate insulating layer 140.

A plurality of ohmic contact islands 163 and 165 preferably made of silicide or n+ hydrogenated a-Si heavily doped with n type impurity are formed on the semiconductor islands 154. The ohmic contact islands 163 and 165 are located in pairs on the semiconductor islands 154.

The lateral sides of the semiconductor islands 150 and the ohmic contacts 163 and 165 are inclined relative to a surface of the substrate 110, and the inclination angles thereof are preferably in a range between about 30-80 degrees.

A plurality of data lines 171 and a plurality of pairs of pixel electrode lines 191 separated from each other are formed on the ohmic contacts 163 and 165 and the gate insulating layer 140.

The data lines 171 for transmitting data voltages extend substantially in the longitudinal direction and intersect the gate lines 121 and the common electrode lines 131. Each pair of the pixel electrode lines 191 extend substantially in the transverse direction and include a plurality of pixel electrodes 190. The pixel electrodes 190 extend parallel to the common electrodes 133, and they are disposed between the common electrodes 133. The pixel electrode lines 191 overlap the common electrode lines 131 and the inner edges of the pixel electrode lines 191 are oblique to inner edges of the pixel electrodes 190.

Each data line 171 includes a plurality of branches projecting toward the gate lines 123 to form a plurality of source electrodes 173, and each pixel electrode line 191 further includes an extension 175 projecting toward the source electrode 173 to form a drain electrode 175. Each pair of the source electrodes 173 and the drain electrodes 175 are disposed opposite each other with respect to a gate electrode 123. A gate electrode 123, a source electrode 173, and a drain electrode 175 along with a semiconductor island 150 form a TFT having a channel formed in the semiconductor island 150 disposed between the source electrode 173 and the drain electrode 175.

The pixel electrodes 190 receive the data voltages from the drain electrodes 175 and generate electric fields in cooperation with the common electrodes 133, which reorient liquid crystal molecules in the liquid crystal layer disposed therebetween. The pixel electrodes 190 and the common electrodes 133 form a liquid crystal capacitor, which stores applied voltages after turn-off of the TFT. An additional capacitor called a “storage capacitor,” which is connected in parallel to the liquid crystal capacitor, is provided for enhancing the voltage storing capacity. The storage capacitors are implemented by overlapping the pixel electrode lines 191 with the common electrode lines 131.

The data lines 171 and the pixel electrode lines 191 are preferably made of a refractory metal such as Cr, Mo, Ti, etc. and they may include a lower film (not shown) preferably made of Mo, Mo alloy or Cr and an upper film (not shown) located thereon and preferably made of Al containing metal.

Like the gate lines 121 and the common electrode lines 131, the data lines 171 and the pixel electrode lines 191 have inclined lateral sides, and the inclination angles thereof range about 30-80 degrees.

The ohmic contacts 163 and 165 are interposed only between the underlying semiconductor islands 150 and the overlying source electrodes 173 and the overlying drain electrodes 175 thereon and reduce the contact resistance therebetween. The semiconductor islands 150 include a plurality of exposed portions, which are not covered with the data lines 171 and the drain electrodes 175, such as portions located between the source electrodes 173 and the drain electrodes 175.

A passivation layer 180 is formed on the data lines 171 and the pixel electrode lines 191, and the exposed portions of the semiconductor islands 150. The passivation layer 180 is preferably made of photosensitive organic material having a good flatness characteristic, low dielectric insulating material such as a-Si:C:O and a-Si:O:F formed by plasma enhanced chemical vapor deposition (PECVD), or inorganic material such as silicon nitride.

The description of the upper panel follows.

A light blocking layer 220 called a black matrix for preventing light leakage is formed on an insulating substrate 210 such as a transparent glass and it has open areas facing the areas enclosed by the common electrode lines 131 and the pixel electrode lines 191.

A plurality of color filters are formed on the substrate 210 and the light blocking member 220 and they are disposed substantially in the open areas defined by the light blocking member 220.

An overcoat 250 preferably made of organic material is formed on the color filters 230 and the light blocking member 220. The overcoat 250 protects the color filters 230 and may be omitted.

A pair of alignment layers (not shown) rubbed in a direction oblique to the common electrodes 133 and the pixel electrodes 190 are coated on the overcoat 250 of the upper panel and the passivation layer 180 of the lower panel, and a pair of crossed polarizers 12 and 22 are provided on outer surfaces of the panels.

The upper and the lower panels are spaced apart from each other with a gap that is given by a plurality of spacers (not shown) disposed between the upper panel and the lower panel.

Liquid crystal molecules in the liquid crystal layer 3 are aligned such that their long axes are substantially parallel to surfaces of the substrates 110 and 210 and make oblique angles with the common electrodes 133 and the pixel electrodes 190.

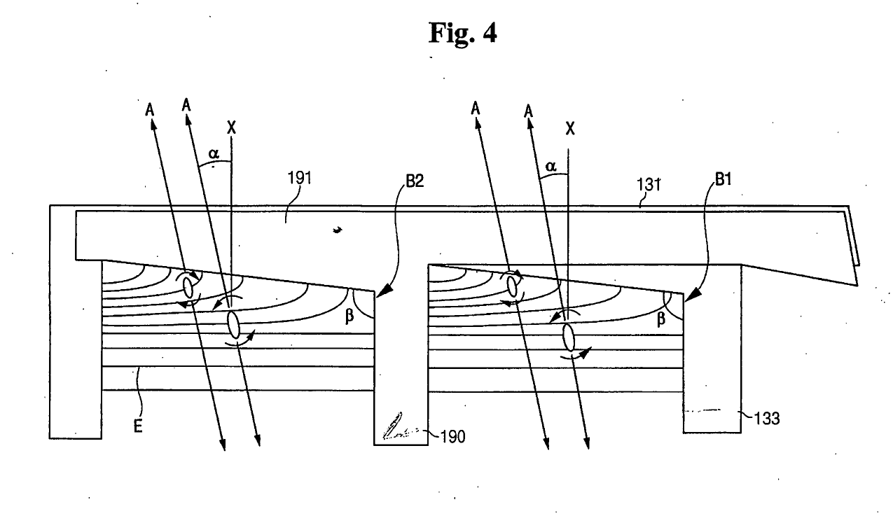

As described above, the inner edges of the pixel electrode lines 191 and the common electrode lines 131 are oblique to the inner edges of the pixel electrodes 190 and the inner edges of the common electrodes 133. A detailed description follows with reference to FIGS. 3 and 4.

FIG. 3 is an expanded view of a common electrode line and a pixel electrode line as well as common electrodes and pixel electrodes connected thereto in an LCD according to an embodiment of the present invention.

Referring to FIG. 3, it is assumed that the common electrodes 133 and the pixel electrodes 190 extend in a direction indicated by X. A rubbing direction A makes a clockwise acute angle a relative to the X axis. Let β1 be an angle formed by an inner edge of a common electrode 133 and an inner edge of a common electrode line 131 connected thereto, and β2 be an angle formed by an inner edge of a pixel electrode 190 and an inner edge of a pixel electrode line 191 connected thereto. Then, the angles β1 and β2 are obtuse and an angle of (β1-90 degrees) and an angle of (β2-90 degrees) are larger than the angle α, that is, the inner edges of the common electrode line 131 and the pixel electrode line 191 make obtuse angles relative to the rubbing direction A in a clockwise manner. Similarly, the inner edges of the common electrode line 131 and the pixel electrode line 191 make obtuse angles relative to the rubbing direction A in a counterclockwise manner when the rubbing direction makes a counterclockwise acute angle. It is noted that one of the inner edge of the common electrode line 131 and the inner edge of the pixel electrode line 191 overlaps the pixel electrode line 191 or the common electrode line 131 and the overlapping edge need not be considered since it may not make significant effect on the orientations of the liquid crystal molecules. For example, an inner edge of the pixel electrode line 191 overlapping the common electrode line 131 may make any angle with the inner edge of the pixel electrode 190. The exposed edge of the common electrode line 131 or the pixel electrode line 191 is focused on in this embodiment.

This configuration reduces textures due to the distortion of an electric field near connections B1 and B2 between the pixel electrodes 190 and the pixel electrode lines 191 and between the common electrodes 133 and the common electrode lines 131, which will be described in detail with reference to FIGS. 3-5.

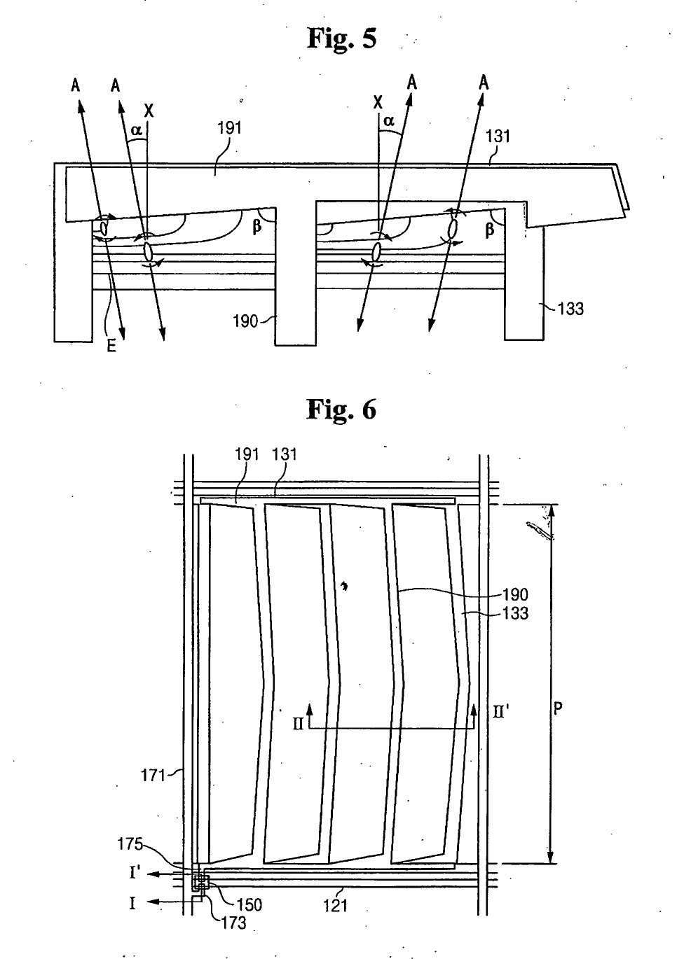

FIGS. 4 and 5 are expanded views of a common electrode line and a pixel electrode line as well as common electrodes and pixel electrodes connected thereto in LCDs according to comparative examples of the present invention.

Referring to FIGS. 3-5, upon application of the common voltage and the data voltage to common electrodes 133 and pixel electrodes 190 as well as to a common electrode line 131 and a pixel electrode line 190, an electric field substantially parallel to the surfaces of the panels is generated. The lines of force of the electric field are perpendicular to the X-axis at most places, but they curve upward from the left to the right and they finally make an angle of about 90 degrees with inner edges of the common electrode lines 131 and the pixel electrode lines 191. The liquid crystal molecules tend to change their orientations in response to the electric field such that their long axes are parallel to the field direction if the liquid crystal layer 3 has positive dielectric anisotropy.

Referring to FIGS. 3 and 4, inner edges of the common electrode line 131 and the pixel electrode line 191 make obtuse angles relative to inner edges of the common electrode 133 and the pixel electrode 190, respectively, and the initial molecular director of the liquid crystal layer 3 makes obtuse angles with the inner edges of the common electrode line 131 and the pixel electrode line 191 in absence of electric field.

Referring to FIG. 3, the initial molecular director makes a clockwise acute angle relative to the X-axis. Upon application of an electric field, the lines of electric force of the electric field make clockwise acute angles relative to the initial molecular director at most places and thus the liquid crystal molecules rotate clockwise. Near the inner edges of the common electrode line 131 and the pixel electrode line 191 where the force lines make an angle of 90 degrees with the inner edges, the force lines still make a clockwise acute angle relative to the initial molecular director since the inner edges make clockwise obtuse angles relative to the initial molecular director. Accordingly, almost all the molecules rotate the same direction, i.e., in the clockwise manner.

Referring to FIG. 4, the initial molecular director makes a counterclockwise acute angle from the X-axis. Upon application of an electric field, the lines of electric force of the electric field make counterclockwise acute angles relative to the initial molecular director at most places and thus the liquid crystal molecules rotate counterclockwise. Near the inner edges of the common electrode line 131 and the pixel electrode line 191, the force lines make a clockwise acute angle relative to the initial molecular director such that the liquid crystal molecules near the inner edges rotate clockwise since the inner edges make clockwise obtuse angles relative to the initial molecular director. Consequently, the molecules near the inner edges rotate in a reversed manner compared with other molecules, which results in texture.

Referring to FIG. 5, the inner edges of the common electrode line 131 and the pixel electrode line 191 make acute angles relative to inner edges of the common electrode 133 and the pixel electrode 190, respectively.

When the initial molecular director makes a counterclockwise acute angle from the X-axis, the force lines make counterclockwise acute angles relative to the initial molecular director at most places and thus the liquid crystal molecules rotate counterclockwise. The force lines become to be perpendicular to the initial molecular director and then to make a clockwise acute angle relative to the initial molecular director such that the liquid crystal molecules rotate clockwise as they go to the right. Accordingly, some molecules rotate in a reversed manner compared with other molecules, which results in texture.

When the initial molecular director makes a clockwise acute angle from the X-axis, the force lines make clockwise acute angles relative to the initial molecular director at most places and thus the liquid crystal molecules rotate clockwise. Near the inner edges of the common electrode line 131 and the pixel electrode line 191, the force lines make a counterclockwise acute angle relative to the initial molecular director since the inner edges make clockwise acute angles relative to the initial molecular director. Accordingly, the molecules near the inner edges rotate in a reversed manner compared with other molecules, which results in texture.

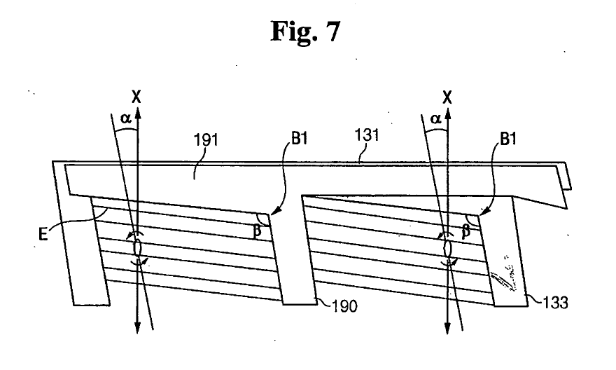

An LCD according to another embodiment of the present invention will be described in detail with reference to FIGS. 6 and 7.

FIG. 6 is a layout view of an LCD according to another embodiment of the present invention, and FIG. 7 is an expanded view of a common electrode line and a pixel electrode line as well as common electrodes and pixel electrodes connected thereto in the LCD shown in FIG. 6.

As shown in FIGS. 6 and 7, a layered structure of an LCD according to this embodiment is almost the same as that shown in FIGS. 1 and 2.

That is, the LCD according to this embodiment includes upper and lower panels, and a liquid crystal layer interposed between the panels.

Concerning a lower panel, a plurality of gate lines 121 including a plurality of gate electrodes 123 and a plurality of common electrodes lines 131 including a plurality of common electrodes 133 are formed on a substrate 110, and a gate insulating layer 140, a plurality of semiconductor islands 150, and a plurality of ohmic contact islands 163 and 165 are sequentially formed thereon. A plurality of data lines 171 including a plurality of source electrodes 173 and a plurality of pixel electrode lines 191 including a plurality of drain electrodes 175 and a plurality of pixel electrodes 190 are formed on the ohmic contacts 163 and 165, and a passivation layer 180 is formed thereon.

Concerning the upper panel, a light blocking layer, a plurality of color filters, and an overcoat are formed on an insulating substrate.

In addition, a pair of alignment layers (not shown) rubbed in a direction oblique to the common electrodes 133 and the pixel electrodes 190 are coated on the overcoat of the upper panel and the passivation layer 180 of the lower panel, and a pair of crossed polarizers 12 and 22 are provided on outer surfaces of the panels.

Different from the lower panel shown in FIGS. 1 and 2, the pixel electrodes 190 and the common electrodes 133 are oblique and curved and the alignment layers are rubbed in the longitudinal direction such that liquid crystal molecules in the liquid crystal layer are aligned oblique to the pixel electrodes 190 and the common electrodes 133.

In FIG. 7, the rubbing direction is indicated by X and the common electrodes 133 and the pixel electrodes 190 make counterclockwise acute angle a relative to the initial molecular director of the liquid crystal layer. Like the LCD shown in FIGS. 1-3, an angle formed by an inner edge of a common electrode 133 and an inner edge of a common electrode line 131 connected thereto, and an angle formed by an inner edge of a pixel electrode 190 and an inner edge of a pixel electrode line 191 connected thereto are obtuse. In addition, the inner edges of the common electrode line 131 and the pixel electrode line 191 make obtuse angles relative to the rubbing direction in a clockwise manner. Similarly, the inner edges of the common electrode line 131 and the pixel electrode line 191 make obtuse angles relative to the rubbing direction A in a counterclockwise manner when the rubbing direction makes a counterclockwise acute angle relative to the pixel electrodes 190 and the common electrode 133.

This configuration reduces textures due to the distortion of an electric field near connections between the pixel electrodes 190 and the pixel electrode lines 191 and between the common electrodes 133 and the common electrode lines 131.

In the meantime, the angle made by the direction of the force lines of the electric field in an upper half relative to the initial molecular director is opposite the angle made by the force direction in a lower half relative to the initial molecular director. Accordingly, the texture is generated near a boundary between the lower half and the upper half. However, experiments show that the texture is dominantly reduced when the pitch of the curve is larger than about 50 microns.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. A liquid crystal display comprising:
first and second substrates;
a common electrode formed on the first substrate;
a common electrode line connected to the common electrode and making an obtuse angle with the common electrode;
a pixel electrode formed on the first substrate and alternately arranged with the common electrode;
a pixel electrode line connected to the pixel electrode and making an obtuse angle with the pixel electrode; and
a liquid crystal layer interposed between the first and the second substrates,
wherein a first edge of the common electrode line makes an obtuse angle relative to an initial molecular director and a first edge of the pixel electrode line makes an obtuse angle relative to the initial molecular director.

2. The liquid crystal display of claim 1, wherein the initial molecular director makes clockwise acute angles relative to the common electrode and the pixel electrode and makes counterclockwise obtuse angles with the edges of the common electrode line and the pixel electrode line.

3. The liquid crystal display of claim 1, wherein the initial molecular director makes counterclockwise acute angles relative to the common electrode and the pixel electrode and makes clockwise obtuse angles with the edges of the common electrode line and the pixel electrode line.

4. The liquid crystal display of claim 1, wherein a second edge of the common electrode line extends substantially perpendicular to the common electrode, and a second edge of the pixel electrode line extends substantially perpendicular to the pixel electrode.

5. The liquid crystal display of claim 1, wherein the pixel electrode and the common electrode are curved.

6. The liquid crystal display of claim 5, wherein a second edge of the common electrode line is oblique to the common electrode and a second edge of the pixel electrode line is oblique to the pixel electrode.

7. The liquid crystal display of claim 5, wherein a pitch of the curving of the pixel electrode and the common electrode is larger than about 50 microns.

8. A panel for a liquid crystal display, the panel comprising:
a substrate;
a common electrode formed on the substrate;
a common electrode line connected to the common electrode and making an obtuse angle with the common electrode;
a pixel electrode formed on the substrate and alternately arranged with the common electrode;
a pixel electrode line connected to the pixel electrode and making an obtuse angle with the pixel electrode; and
an alignment layer formed on the substrate and rubbed in a direction,
wherein a first edge of the common electrode line makes an obtuse angle relative to the rubbed direction and a first edge of the pixel electrode line makes an obtuse angle relative to the rubbed direction.

9. The panel of claim 8, wherein the rubbed direction makes clockwise acute angles relative to the common electrode and the pixel electrode and makes counterclockwise obtuse angles with the edges of the common electrode line and the pixel electrode line.

10. The liquid crystal display of claim 8, wherein the rubbed direction makes counterclockwise acute angles relative to the common electrode and the pixel electrode and makes clockwise obtuse angles with the edges of the common electrode line and the pixel electrode line.
